(19) United States
(12) Patent Application Publication
(10) Pub. No.: US 2022/0152971 A1
(43) Pub. Date: May 19, 2022

(54) LAYER ARRANGEMENT WITH 3D STRUCTURE AND 2D PROJECTION OF SAID STRUCTURE

(71) Applicant: Covestro Intellectual Property GmbH & Co. KG, Leverkusen (DE)

(72) Inventors: Ulrich Grosser, Kürten (DE); Thomas Grimm, Köln (DE); Christoph Klinkenberg, Köln (DE); Konstantin Leonhardt, Grevenbroich (DE)

(21) Appl. No.: 17/602,807

(22) PCT Filed: Apr. 9, 2020
(86) PCT No.: PCT/EP2020/060121

§ 371 Date: Oct. 11, 2021

(30) Foreign Application Priority Data
Apr. 16, 2019 (EP) 19169559.2

(51) Int. Cl. B32B 3/26; B32B 7/12; B32B 27/08; B32B 27/36

(52) U.S. Cl. CPC B32B 3/263; B32B 7/12; B32B 27/08; B32B 27/365; B32B 2307/584; B32B 2307/4023; B32B 2307/412; B32B 2250/244; B32B 2307/732; B32B 2255/26; B32B 2255/10; B32B 2605/003; B32B 2250/02

(57) ABSTRACT

The present invention relates to a layer arrangement, having: a foil layer (100) provided with optical information, and a three-dimensionally structured layer (200) having a smooth side (210) and a structured side (220) opposite the smooth side (210), wherein the structured side (220) has at least one face (230) which is not coplanar with the smooth side (210) and faces a previously defined reference location (400), and the structured side (220) has at least one face (235) which is not coplanar with the smooth side (210) and faces away from the previously defined reference location (400). The three-dimensionally structured layer (200) is formed by a thermoplastic polymer which has an optical haze Ty (D65/10°) according to ASTM D1003 of ≥10% with a layer thickness of 4 mm. The foil layer (100) provided with optical information is connected to the structured side (220) of the three-dimensionally structured layer (200). The foil layer (100) provided with optical information is printed with at least one part of a two-dimensional projection (500) of the three-dimensionally structured layer (200), and the projection (520) of the at least one face (230) facing the reference location (400) is shown differently on the foil layer (100) provided with optical information than the projection (530) of the at least one face (235) facing away from the reference location (400).

The present invention relates to a layer arrangement, comprising: a foil layer provided with optical information and a three-dimensionally structured layer with a smooth side and with a structured side opposite to the smooth side. The structured side has at least one surface area which is not coplanar with the smooth side and which faces toward a predefined reference location, and the structured side has at least one surface area which is not coplanar with the smooth side and which faces away from a predefined reference location. The three-dimensionally structured layer is formed by a thermoplastic polymer which, at a layer thickness of 4 mm, has an optical clarity Ty (D65/10°) of ≥10% in accordance with ASTM D1003, and the foil layer provided with optical information is bonded to the structured side of the three-dimensionally structured layer.

WO 2009/083198 A1 describes a process for the three-dimensional reproduction of a relief original and/or image original with use, as relief base material, of a smooth thermoplastic foil which is provided with a graphical depiction of the relief original and/or image original, and in particular is printed, and of a positive relief mold where, during a thermoplastic deformation step, said foil is brought into precisely fitting mutual superposition with the positive relief mold and is thermoplastically deformed with exposure to heat. The intention in WO 2009/083198 A1 is to devise a solution that provides a simplified process for the reproduction of a relief and/or image original. According to WO 2009/083198 A1, this is achieved by carrying out the following steps: a) provision of the thermoplastic foil, b) with position-marking of their position relative to one another, precisely fitting arrangement, on or at a small distance above the image side of the foil, of a relief mold base material through which the foil can be seen, c) by application of a relief mold material that shapes and forms the positive relief mold, application, in correspondence with the graphical depiction, of the relief structure to that side of the relief mold base material that faces away from the image side of the foil, d) introduction of the positive relief mold into a heat-treatment device, e) in correspondence with the position-marking from the step b), precisely fitting placement, onto the structured upper side of the positive relief mold, of that side of the foil that faces away from the image, and f) thermoplastic deformation of, and/or embossing of, the foil.

Three-dimensional relief patterns can represent aesthetically pleasing decorative elements. However a disadvantage hitherto is that when the designer wishes to achieve more optical “depth” this always requires processing of a greater quantity of material.

The present invention has addressed the object of providing a layer arrangement which has reduced total thickness but where the three-dimensional structures present in the layer arrangement can nevertheless provide an impression of three-dimensional depth. With this type of layer arrangement it is possible to produce aesthetically pleasing decorative elements, for example for the interior of vehicles, without any need to process an excessive quantity of material.

The object is achieved according to the invention by a layer arrangement as claimed in claim 1. Claim 15 provides a production process. Advantageous further developments are stated in the dependent claims. They can be combined in any desired manner, unless the context clearly indicates the opposite.

With the layer arrangements according to the invention it is possible, through the optical interaction between the 3D structures and the 2D projection of said structures, to achieve pleasing effects with attractive three-dimensional qualities, with reduced structural thickness and therefore with saving of material.

The invention is explained in more detail with reference to the following drawings, but without any restrictions thereto.

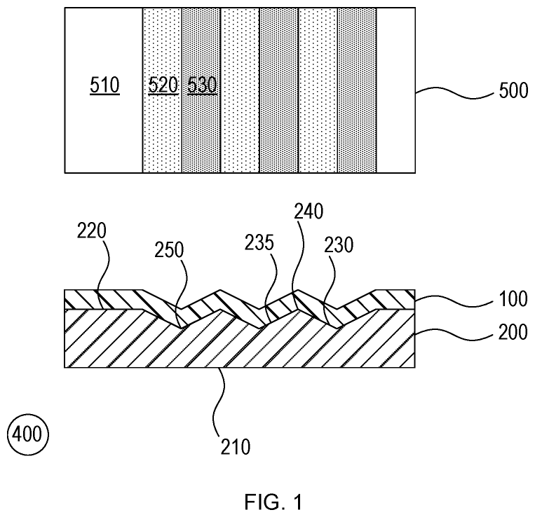

FIG. 1 shows a layer arrangement and projection according to the invention.

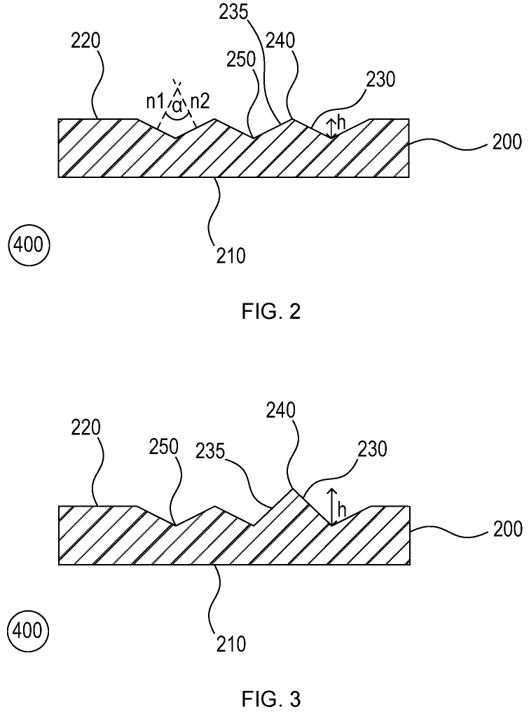

FIGS. 2 to 5 show further layer arrangements according to the invention.

FIG. 1 is a diagram of a layer arrangement according to the invention, comprising a foil layer 100 provided with optical information and a three-dimensionally structured layer 200 with a smooth side 210 and with a structured side 220 opposite to the smooth side 210. “Optical information” here can be represented by various printed effects (in which case the foil 100 is a printed foil), colorings or surface-roughness effects in selective regions of the foil 100. It is moreover possible that the foil 100 is conceived as optical conductor and that the optical information is represented by selective output of light which has been input laterally into the foil 100.

There is no restriction on the position of the information in or on the foil 100. The information can thus be represented on that side of the foil 100 that faces toward the structured layer 200, or can be present on that side of the foil 100 that faces away from the structured layer 200, or else within the foil 100.

The layer arrangement can be designed to be planar or else nonplanar (curved). Correspondingly, the smooth side 210 can be planar or curved. It is preferable that the smooth side 210 has no elevations or depressions other than technically unavoidable fluctuations.

The structured side 220 has at least one surface area 230 which is not coplanar with the smooth side 210 and which faces toward a predefined reference location 400. This type of surface 230 is formed by elevations or peaks 240 and/or depressions or valleys 250 on the structured side 220. The reference location 400 can be a reference point. It is an imaginary position which can be interpreted as the eye of an observer or as light source (for creating or simulating shadows projected onto the structured side 220). The structured side 220 moreover has at least one surface area 235 which is not coplanar with the smooth side 210 and which faces away from the predefined reference location 400.

The three-dimensionally structured layer 200 is formed by a thermoplastic polymer which, at a layer thickness of 4 mm, has an optical clarity Ty (D65/10°) of ≥10% in accordance with ASTM D1003. The 3D-structured layer 200 can therefore be regarded as transparent or at least to some extent transparent.

Examples of suitable thermoplastic polymers are the members selected from the group comprising polycarbonate, polyester carbonate, polystyrene, polyamide, styrene copolymers, aromatic polyesters, PET-cyclohexanedimethanol copolymer (PETG), polyethylene naphthalate (PEN), polybutylene terephthalate (PBT), poly- or copolyacrylates and poly- or copolymethacrylate and also copolymers with styrene.

The term polycarbonate here also comprises copolycarbonates. In the case of styrene copolymers, preference is given to acrylonitrile-styrene-acrylate copolymer (ASA), and in the case of aromatic polyesters preference is given to polyethylene terephthalate (PET), and in the case of poly- or copolymethacrylate preference is given to poly- or copolymethyl methacrylates, in particular polymethyl methacrylate (PMMA), and in the case of copolymers with styrene preference is given to transparent polystyrene-acrylonitrile (PSAN).

It is self-evident that the thermoplastic polymer can comprise additives such as colorants, stabilizers, impact modifiers and the like. The optical clarity Ty is preferably ≥20% to ≤99%, and more preferably ≥50% to ≤92%.

The foil layer 100 provided with optical information is bonded to the structured side 220 of the three-dimensionally structured layer 200. Said bonding can by way of example be achieved in in-mold foil coating. It is preferable that the foil 100 conforms to the profile of the structured side 220. This is also the situation depicted in FIG. 1.

A feature of the layer arrangement according to the invention is that the optical information of the foil layer 100 provided with optical information represents at least a portion of a two-dimensional projection 500 of the three-dimensionally structured layer 200. It is preferable that the foil layer 100 is provided with the complete projection of the 3D-structured layer 200. For clarification the projection 500 is depicted in FIG. 1 above the layer arrangement. In the projection 500, which represents the entire projection, it is possible to discern projections 510, 520 and 530, the boundaries between which are defined by the elevations 240 and depressions 250 of the structured side 220. The projection 500 therefore comprises at least the projections 520 and 530.

The manner in which the projection 520 of the at least one surface area 230 facing toward the reference location 400 is represented on the foil layer 100 provided with optical information differs from the manner in which the projection 530 of the at least one surface area 235 facing away from the reference location 400 is represented. The direction of facing, toward or away from, the reference location 400 can by way of example define illumination effects or shadow effects on the surface areas. This is comparable with the representation of mountains (a three-dimensional structure) in a map (a two-dimensional structure). A reference location for a light source is selected, and on the basis of this hillsides facing away from the light source are represented in darker color or with shadowing. A three-dimensional impression of the mountain is thus provided on the map.

The projection 500 can be obtained by using a ray-tracing method to convert a three-dimensional CAD model of the structured layer 200 to a two-dimensional image.

It is possible that, in the projection 500, horizontal sections of the structured side 220 are not colored or represented in any other manner by optical information. This is also depicted in FIG. 1 by the projection 510. The absence of coloring thereof amplifies the optical impression created by the other projections 520 and 530.

In one embodiment, which is likewise shown in FIG. 1, the projection 500 is an orthogonal, projection with no offset. The foil 100, together with the projection, is then congruent with the structured side 220.

In another embodiment, which is likewise shown in FIG. 1, the reference location 400 is aligned with the smooth side 210 of the three-dimensionally structured layer 200. The layer arrangement according to the invention can be used as screening panel or as decorative component. It is preferable that then the smooth side 210 is the side facing toward an observer, the reference point 400 therefore representing a possible position of an observer.

In another embodiment, which is likewise shown in FIG. 1, the reference location 400 is arranged outside of the vertical boundaries of the layer arrangement.

FIG. 2 shows the layer arrangement depicted in FIG. 1, without the projection 500 and, in order to improve clarity, without the foil layer 100 provided with optical information, but instead with additional geometric descriptors h, n1, n2 and α. In another embodiment, the maximal vertical distance h between a peak 240 and an adjacent valley 250 in the structured side 220 of the three-dimensionally structured layer 200 is ≤2 mm. The distance h is preferably ≥0.1 mm to ≤1.5 mm and more preferably ≥0.2 mm to ≤0.9 mm. The height h can certainly be selected in a manner such that the peak 240 associated therewith projects beyond the horizontal plane of the structured side 220. This is depicted by way of example in

FIG. 3. In FIG. 3, in order to improve clarity, the foil layer 100 provided with optical information is likewise not depicted.

These restricted values for the distance h have the advantage that the three-dimensional structure is sufficiently flat to remove any need for preforming of the foil during the production of the layer arrangement; said foil can instead be inserted in the form of two-dimensional foil into an injection mold (for in-mold foil coating).

Another advantage of such restricted values for the distance h is that the optical quality of the smooth side 210 can be improved. The overall effect of smaller height differences in the structured side 220, i.e. of smaller h, is that the fluctuation in the mass of the thermoplastic polymer, perpendicular to the smooth side 210, is also smaller. This then results in greater uniformity of cooling behavior of the thermoplastic. Optical defects due to inhomogeneous cooling of the thermoplastic are thus avoided. The layer arrangement nevertheless gives a pleasing three-dimensional optical impression as a result of combination with the foil 100.

In another embodiment, which is likewise shown in FIG. 2, a straight line n1 perpendicular to a surface area 230 facing toward the reference location 400 and a straight line n2 perpendicular to an adjacent surface area 235 facing away from the reference location 400 intersect at an angle α of ≥5° to ≤175°. It is thus possible to quantify the inclination of the surface areas 230, 235. The angle a is preferably ≥20° to ≤70°, and more preferably ≥30° to ≤60°.

In another embodiment, the foil layer 100 is provided with optical information by means of laser structuring, inkjet printing, laser printing, digital printing or screen printing. Preference is given to a printing process such as screen printing, so that the foil layer 100 is a printed foil layer, the printed foil layer 100 has been printed with at least a portion of a two-dimensional projection 500 of the three-dimensionally structured layer 200, and the manner in which the projection 520 of the at least one surface area 230 facing toward the reference location 400 is represented on the printed foil layer 100 differs from the manner in which the projection 530 of the at least one surface area 235 facing away from the reference location 400 is represented.

In another embodiment, where reference can be made to FIG. 1, the projection 520, of the foil layer 100 provided with optical information, of the at least one surface area 230 which faces toward the reference location 400 has a lower tonal value than the projection 530 of the at least one surface area 235 which faces away from the reference location 400. The expression tonal value relates to the various graduations between light and dark in a color image or black-and-white image, either in a digital data set, on a transparent carrier (film) or on a frontally viewed photographic or printed image. Said expression describes, for an element (point) in an image, a color value or gray value, stated in terms of 0 to 100%,within a prescribed graduated range of color values or gray values. 100% here means maximal darkness or color opacity (maximal tonality) of the imaging medium. Correspondingly, 0% means complete transparency of the film or blank paper in the case of matrix printing. The tonal value is determined from measurements of the optical density or the reflectivity, and is calculated from these measured values in accordance with the Murray-Davies formula.

In the additive CMYK color model, which is used in printing processes, the gray value can be expressed as percentage proportion of the component K (“key”, black). It is preferable that, on the foil layer 100 provided with optical information, the projection 520 of the at least one surface area 230 which faces toward the reference location 400 has a lower gray value in the CMYK color model than the projection 530 of the at least one surface area 235 which faces away from the reference location 400. In the simplest way of analogy described above, “hillsides” facing away from the light source are depicted as darker than those “hillsides” that face toward the light source.

In another embodiment, where reference can likewise be made to FIG. 1, the tonal value of the projection 520 of the at least one surface area 230 which faces toward the reference location 400 is selected as a function of the angular deviation of the surface area 230 from horizontal. In the simplified analogy described above, the “hillsides” facing toward the light source are depicted differently in accordance with their inclination.

In another embodiment, where reference can likewise be made to FIG. 1, the tonal value of the projection 530 of the at least one surface area 235 which faces away from the reference location 400 is selected as a function of the inclination of the surface area 235. In the simplified analogy described above, the “hillsides” facing away the light source are depicted differently in accordance with their inclination, in particular being depicted as darker.

The function in the two last-mentioned embodiments can by way of example be, mutually independently, a linear function or a logarithmic function. A logarithmic function is advantageous for reflecting the logarithmic character of sensory perceptions in humans.

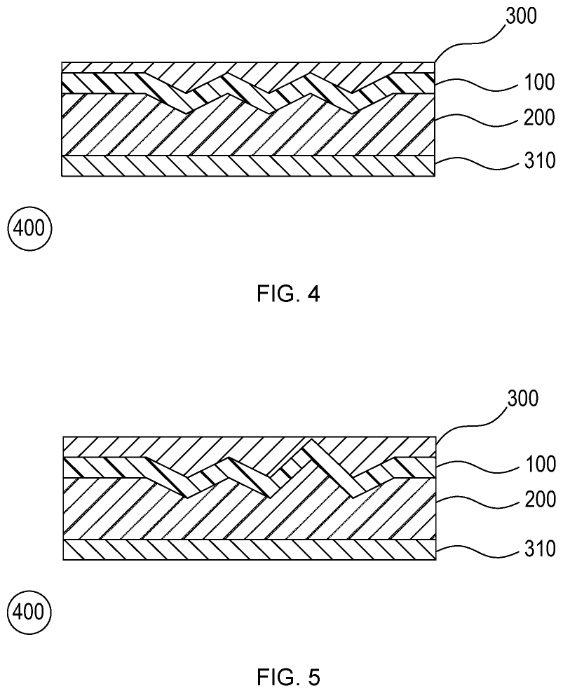

In another embodiment, which is depicted in FIGS. 4 and 5, there is moreover a first additional layer 300 present on that side of the foil layer 100 provided with optical information that faces away from the structured side 220 of the three-dimensionally structured layer 200, bonded to said foil layer. Additionally or alternatively, on the smooth side 210 of the three-dimensionally structured layer 200 a second additional layer 310 is moreover present, bonded to said structured layer. The first additional layer 300 and second additional layer 310 can mutually independently be realized via a foil or a lacquer, via deposition from a vapor or via plasma coating. This type of additional layer 300, 310 can protect the layer arrangement from soiling or scratching.

In another embodiment, the thermoplastic polymer of which the three-dimensionally structured layer 200 is composed is a polycarbonate. This term also covers copolycarbonates and polycarbonate blends. The melt flow rate MVR of the polycarbonate can be 8 to 20 cm³/(10 min), determined in accordance with ISO 1133-1:2012-03 (300° C., 1.2 kg). Preference is given to the homopolycarbonate based on bisphenol A, the homopolycarbonate based on 1,1-bis(4-hydroxyphenyl)-3,3,5-trimethylcyclohexane, a copolycarbonate comprising isosorbide, 2,3-dihydro-3,3-bis(4-hydroxyphenyl)-2-methyl-1H-isoindol-1-one, 2,3-dihydro-3,3-bis(4-hydroxyphenyl)-2-phenyl-1H-isoindol-1-one, 1,3-dihydro-3,3-bis(4-hydroxyphenyl)-1-methyl-2H-indol-2-one, 1,3-dihydro-3,3-bis(4-hydroxyphenyl)-1-phenyl-2H-indol-2-one, 1,2-dihydro-2,2-bis(4-hydroxyphenyl)-1-methyl-3H-indol-3-one and/or 1,2-dihydro-2,2-bis(4-hydroxyphenyl)-1-phenyl-3H-indol-3-one, a copolycarbonate based on the monomers of bisphenol A and 1,1-bis(4-hydroxyphenyl)-3,3,5-trimethylcyclohexane, or a mixture of at least two of the abovementioned polymers. The polycarbonate can, of course, comprise additives such as dyes, stabilizers, impact modifiers and the like.

The foil layer 100 preferably comprises one or more thermoplastic polymers. Examples have already been mentioned above. In another embodiment, the foil layer 100 provided with optical information comprises a polycarbonate. This term also covers copolycarbonates and polycarbonate blends. The melt flow rate MVR of the polycarbonate can be 8 to 20 cm³/(10 min), determined in accordance with ISO 1133-1:2012-03 (300° C., 1.2 kg). Preference is given to the homopolycarbonate based on bisphenol A, the homopolycarbonate based on 1,1-bis(4-hydroxyphenyl)-3,3,5-trimethylcyclohexane, a copolycarbonate comprising isosorbide, 2,3-dihydro-3,3-bis(4-hydroxyphenyl)-2-methyl-1H-isoindol-1-one, 2,3-dihydro-3,3-bis(4-hydroxyphenyl)-2-phenyl-1H-isoindol-1-one, 1,3-dihydro-3,3-bis(4-hydroxyphenyl)-1-methyl-2H-indol-2-one, 1,3-dihydro-3,3-bis(4-hydroxyphenyl)-1-phenyl-2H-indol-2-one, 1,2-dihydro-2,2-bis(4-hydroxyphenyl)-1-methyl-3H-indol-3-one and/or 1,2-dihydro-2,2-bis(4-hydroxyphenyl)-1-phenyl-3H-indol-3-one, a copolycarbonate based on the monomers of bisphenol A and 1,1-bis(4-hydroxyphenyl)-3,3,5-trimethylcyclohexane, or a mixture of at least two of the abovementioned polymers. The polycarbonate can, of course, comprise additives such as dyes, stabilizers, impact modifiers and the like.

In another embodiment, the first additional layer 300 and/or the second additional layer 310 is/are composed of a two-component lacquer (2C lacquer), of a coextruded foil or of a scratch-resistant-coated foil. It is preferable that the scratch-resistant-coated foil is a polycarbonate foil provided with a coating comprising silicon oxide nanoparticles.

In another embodiment: the thickness of the foil layer 100 provided with optical information is ≥100 μm bis ≤1000 μm (preferably ≥175 μm to ≤500 μm, more preferably ≥250 μm to ≤375 μm), and/or the maximal thickness of the three-dimensionally structured layer 200 is ≥1.5 mm to ≤6 mm (preferably ≥2 mm to ≤5 mm, more preferably ≥3 mm to ≤4 mm)

The layer arrangement of the invention can be used as decorative component or as decorative screening panel. Preferred application sectors are exterior or interior components of vehicles.

A process for the production of a layer arrangement of the invention comprises the following steps:
selection of a three-dimensional structure, where the structure has at least one surface area 230 which has angular deviation from horizontal and which faces toward a predefined reference location 400 and
where the structure has at least one surface area 235 which has angular deviation from horizontal and which faces away from the predefined reference location 400,
generation, on a foil 100, of optical information which represents at least a portion of a two-dimensional projection 500 of the selected three-dimensional structure,
where the manner in which a projection 520 of the at least one surface area 230 facing toward the reference location 400 is represented on the foil 100 differs from the manner in which the projection 530 of the at least one surface area 235 facing away from the reference location 400 is represented,
production of a three-dimensionally structured layer 200, corresponding to the selected three-dimensional structure, from a thermoplastic polymer, where the polymer has, at a layer thickness of 4 mm, an optical clarity Ty (D65/10°) of ≥10% in accordance with ASTM D1003,
in the manner such that the three-dimensionally structured layer 200 has a smooth side 210 and a structured side 220 opposite to the smooth side 210,
bonding of the foil 100 to the structured side 220 of the three-dimensionally structured layer 200.

The principles of the embodiments mentioned in connection with the subject matter of the invention can, of course, also be applied to the process. The optical information on the foil 100 can therefore preferably be produced by printing, and the foil 100 is preferably bonded to the layer 200 in a manner such that the projection of the 3D structure is congruent with the structured side 220.

1. A layer arrangement, comprising:
a foil layer (100) provided with optical information and
a three-dimensionally structured layer (200) with a smooth side (210) and with a structured side (220) opposite to the smooth side (210), wherein the structured side (220) has at least one surface area (230) which is not coplanar with
the smooth side (210) and which faces toward a predefined reference location (400) and
wherein the structured side (220) has at least one surface area (235) which is not coplanar with the smooth side (210) and which faces away from the predefined reference location (400),
wherein the three-dimensional structured layer (200) is formed by a thermoplastic polymer which, at a layer thickness of 4 mm, has an optical clarity Ty (D65/10°) of ≥10% in accordance with ASTM D1003,
wherein the foil layer (100) provided with optical information is bonded to the structured side (220) of the three-dimensionally structured layer (200),
wherein the optical information of the foil layer (100) provided with optical information represents at least a portion of a two-dimensional projection (500) of the three-dimensionally structured layer (200), and
wherein the maximal vertical distance h between a peak (240) and an adjacent valley (250) in the structured side (220) of the three-dimensionally structured layer (200) is ≤2 mm, and the manner in which a projection (520) of the at least one surface area (230) facing toward the reference location (400) is represented on the foil layer (100) provided with optical information differs from the manner in which a projection (530) of the at least one surface area (235) facing away from the reference location (400) is represented.

2. The layer arrangement as claimed in claim 1, wherein the projection (500) is an orthogonal projection with no offset.

3. The layer arrangement as claimed in claim 1, where the reference location (400) faces toward the smooth side (210) of the three-dimensionally structured layer (200) and/or where the reference location (400) is positioned outside of the vertical boundaries of the layer arrangement.

4. The layer arrangement as claimed in claim 1, wherein the thermoplastic polymer is selected from the group consisting of polycarbonate, copolycarbonate, polyester carbonate, polystyrene, polyamide, styrene copolymers, aromatic polyesters, PET-cyclohexanedimethanol copolymer (PETG), polyethylene naphthalate (PEN), polybutylene terephthalate (PBT), poly-acrylates, copolyacrylates, polymethacrylates, copolymethacrylates, copolymethyl methacrylates (PMMA), and copolymers with styrene, polystyrene-acrylonitrile (PSAN).

5. The layer arrangement as claimed in claim 1, wherein a straight line n1 perpendicular to a surface area (230) facing toward the reference location (400) and a straight line n2 perpendicular to an adjacent surface area (235) facing away from the reference location (400) intersect at an angle α of ≥5° to ≤175°.

6. The layer arrangement as claimed in claim 1, wherein the foil layer (100) is provided with optical information by means of laser structuring, inkjet printing, laser printing, digital printing or screen printing.

7. The layer arrangement as claimed in claim 1, wherein the projection (520), of the foil layer (100) provided with optical information, of the at least one surface area (230) which faces toward the reference location (400) has a lower tonal value than the projection (530) of the at least one surface area (235) which faces away from the reference location (400).

8. The layer arrangement as claimed in claim 7, wherein the tonal value of the projection (520) of the at least one surface area (230) which faces toward the reference location (400) is selected as a function of the angular deviation of the surface area (230) from horizontal.

9. The layer arrangement as claimed in claim 7, wherein the tonal value of the projection (530) of the at least one surface area (235) which faces away from the reference location (400) is selected as a function of the angular deviation of the surface area (235) from horizontal.

10. The layer arrangement as claimed in claim 1, wherein there is on a side of the foil layer (100) provided with optical information that faces away from the structured side (220) of the three-dimensionally structured layer (200) a first additional layer (300) present, bonded to the foil layer, and there is on the smooth side (210) of the three-dimensionally structured layer (200) a second additional layer (310) present, which is bonded to the structured layer.

11. The layer arrangement as claimed in claim 1, wherein the thermoplastic polymer from which the three-dimensionally structured layer (200) is formed is a polycarbonate.

12. The layer arrangement as claimed in claim 1, wherein the foil layer (100) provided with optical information comprises a polycarbonate.

13. The layer arrangement as claimed in claim 10, wherein the first additional layer (300) and the second additional layer (310) are formed of one selected from the group consisting of a two-component lacquer a coextruded foil, and a foil having a scratch-resistant coating.

14. The layer arrangement as claimed in claim 1, wherein
the thickness of the foil layer (100) provided with optical information is ≥100 μm to ≤1000 μm and
the maximal thickness of the three-dimensionally structured layer (200) is ≥1.5 mm to ≤6.0 mm.

15. A process for the production of a layer arrangement as claimed in claim 1, comprising the steps of:
selecting a three-dimensional structure, wherein the structure has at least one surface area (230) which has angular deviation from horizontal and which faces toward a predefined reference location (400) and
wherein the structure has at least one surface area (235) which has angular deviation from horizontal and which faces away from the predefined reference location (400),
generating on a foil (100), optical information which represents at least a portion of a two-dimensional projection (500) of the selected three-dimensional structure, wherein the manner in which a projection (520) of the at least one surface area (230) facing toward the reference location (400) is represented on the foil (100) differs from the manner in which the projection (530) of the at least one surface area (235) facing away from the reference location (400) is represented,
producing a three-dimensionally structured layer (200), corresponding to the selected three-dimensional structure, from a thermoplastic polymer, wherein the polymer has at a layer thickness of 4 mm an optical clarity Ty (D65/10°) of ≥10% in accordance with ASTM D1003,
such that the three-dimensionally structured layer (200) has a smooth side (210) and a structured side (220) opposite to the smooth side (210),
bonding the foil (100) to the structured side (220) of the three-dimensionally structured layer (200).
